(19) United States
(12) Patent Application Publication
(10) Pub. No.: US 2021/0110140 A1
(43) Pub. Date: Apr. 15, 2021

(54) ENVIRONMENT SPECIFIC MODEL DELIVERY

(71) Applicants: Juan Munoz, Folsom, CA (US); Ignacio J. Alvarez, Portland, OR (US); Nilesh Jain, Portland, OR (US); Chaunte W. Lacewell, Hillsboro, OR (US)

(72) Inventors: Juan Munoz, Folsom, CA (US); Ignacio J. Alvarez, Portland, OR (US); Nilesh Jain, Portland, OR (US); Chaunte W. Lacewell, Hillsboro, OR (US)

(21) Appl. No.: 17/131,680

(22) Filed: Dec. 22, 2020

(51) Int. Cl. G06K 9/00; G06K 9/62; G06N 3/08; G06N 3/04; H04L 29/08

(52) U.S. Cl. CPC G06K 9/00201; G06K 9/6227; H04L 67/10; G06N 3/08; G06N 3/0454; G06K 9/6232

(57) ABSTRACT

Disclosed are embodiments providing model data specific to particular object recognition client environments. Model data capable of performing well under all possible conditions can be large, slow, and less accurate, at least in some circumstances. The disclosed embodiments solve this problem by providing smaller, more precisely designed models that are adapted to specific conditions faced by an object recognition client. These smaller, more precise models are extracted, in response to a request for said model data, from a super-net trained via data matching one or more environmental conditions specified by the object recognition client. By providing the client with model data tailored to its specific needs, several technical benefits are achieved, such as higher object recognition accuracy with less processing overhead.

### TECHNICAL FIELD

The present disclosure relates to deployment of artificial intelligence model data. Specifically, the disclosed embodiments describe deployment of model data that is specific to an environment of a client device utilizing the model data.

### BACKGROUND

The use of artificial intelligence to analyze and control an environment is increasing exponentially. AI is being used to improve document processing, manufacturing processes, and even traffic signals. AI will soon enable vehicles that drive themselves. As the value of Al based solutions becomes more apparent, the use of AI is migrating into increasingly disparate application environments. Therefore, AI architectures that function in this variety of application environments are needed.

### BRIEF DESCRIPTION OF THE DRAWINGS

The present disclosure is illustrated by way of example and not limitation in the figures of the accompanying drawings, in which like references indicate similar elements and in which:

FIG. 1 is an overview diagram showing a variety of example visual environments that are experienced by an object recognition device in at least some of the disclosed embodiments.

FIG. 2 shows an example architecture implemented in one or more of the disclosed embodiments.

FIG. 3 shows an example data flow implemented in one or more of the disclosed embodiments.

FIG. 4 is a data flow diagram showing a self-labeling pipeline implemented in some of the disclosed embodiments.

FIG. 5 shows example message portions implemented in one or more of the disclosed embodiments.

FIG. 6 shows example data structures implemented in one or more of the disclosed embodiments.

FIG. 7 is a flowchart of a method for model data for an object recognition client device.

FIG. 8 is a flowchart of a method for obtaining model data.

FIG. 9 illustrates a method of anticipatory model data deployment.

FIG. 10 is a flowchart of an example method of providing updated model data.

FIG. 11 shows an example machine learning module according to some examples of the present disclosure.

FIG. 12 illustrates a block diagram of an example machine upon which any one or more of the techniques (e.g., methodologies) discussed herein may perform.

### DETAILED DESCRIPTION

As discussed above, AI architectures that function in a variety of application environments are needed. Modern AI architectures are challenged to provide models that include high dimensional space images in dynamic environments. Some research has proposed computer vision and/or machine leaning algorithms that attempt to capture variations in appearances of an environment. However, these solutions invest a relatively large amount of resources to develop a model that can function under a variety of environmental conditions. These models are frequently of a large size, with a large number of parameters necessary to support the complexity of the model. These previous solutions also typically rely on limited training datasets.

The present disclosure recognizes that developing a single set of model data to provide for processing of all environments in which an AI application encounters has several disadvantages. First, such a model is of a relatively large size and therefore consumes a relatively large amount of computing resources when stored locally with the AI application. Additionally, changes to a portion of this large model can require the entire model to be updated, resulting in relatively large network processing overhead to transfer data already available at the AI application. The relatively large size of a comprehensive set of model data is particularly problematic when an AI device environment is resource constrained. For example, as AI applications become more pervasive, they are being implemented on relatively small devices that are cost and size sensitive. As such, these devices are not necessarily equipped with large mass storage devices, but frequently can be implemented using embedded platforms that use static memory modules for stable storage. This generally will place size constraints on an amount of stable storage available to the AI application. Large AI models also result in larger latencies when those models are searched. Thus, smaller models have advantages, by mitigating at least some of the disadvantages of larger models discussed above.

Furthermore, the disclosed embodiments recognize that objects recognized by an AI application change over time, at least in some embodiments. Existing solutions do not adapt an object recognition model based on how it is used in deployment, nor do they generally identify the most common objects of interest, consider dynamic changes in the environment, and retrain/redeploy new models in the background to improve results.

To solve these problems, the disclosed embodiments deploy relatively small, efficient machine learning models to remote devices based on environmental conditions at locations of the remote devices. Some of the disclosed embodiments receive information from the remote devices that indicate one or more environmental conditions at the remote device. A model is then selected for deployment to the remote device based on the indicated environmental conditions. Thus, for example, some embodiments deploy a first model when environmental conditions indicate a daytime environment, and a second model when environmental conditions at the remote device indicate nighttime conditions. Some embodiments provide models based on object recognition needs of the remote device. For example, in some embodiments, the remote device indicates, to a remote model deployment system, a set of object types that it needs to recognize in its environment. The remote model deployment system then provides model data tailored for recognition of those object types. Thus, in some embodiments, if the remote device determines an object in its environment could be one of n different objects, but confidence levels associated with recognition of each of those objects is below a threshold, the remote device indicates, in some embodiments, to the remote model deployment system the “n” objects. By providing model data more optimized for recognition of those n different objects, a confidence level obtained by the remote device may improve relative to a previous model.

The disclosed embodiments thus enable a remote device employing a model for object recognition to maintain efficient (e.g., low latency, size, etc.) models tailored to a particular environment, as well as the remote device's hardware environment.

In some embodiments, the remote model deployment system disclosed above provides a service-oriented interface or other API to make model data available to remote devices.

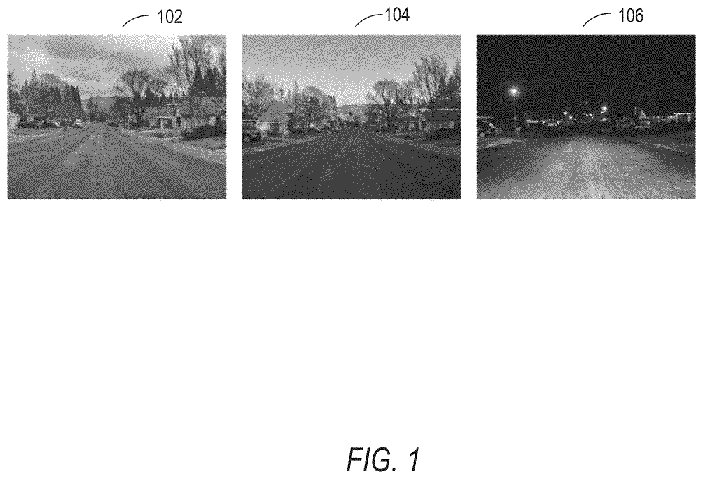

FIG. 1 is an overview diagram showing a variety of example visual environments that are experienced by an object recognition device in at least some of the disclosed embodiments. A first image 102 shows a daytime environment with overcast weather. Image 104 shows the same location with a daytime environment and sunny weather. Image 106 shows the same location at night. Note how the lighting conditions of image 106 differs from that of the other two example images. In at least some of the disclosed embodiments, AI models perform object recognition on images exhibiting characteristics analogous to those of images 102, 104, or 106.

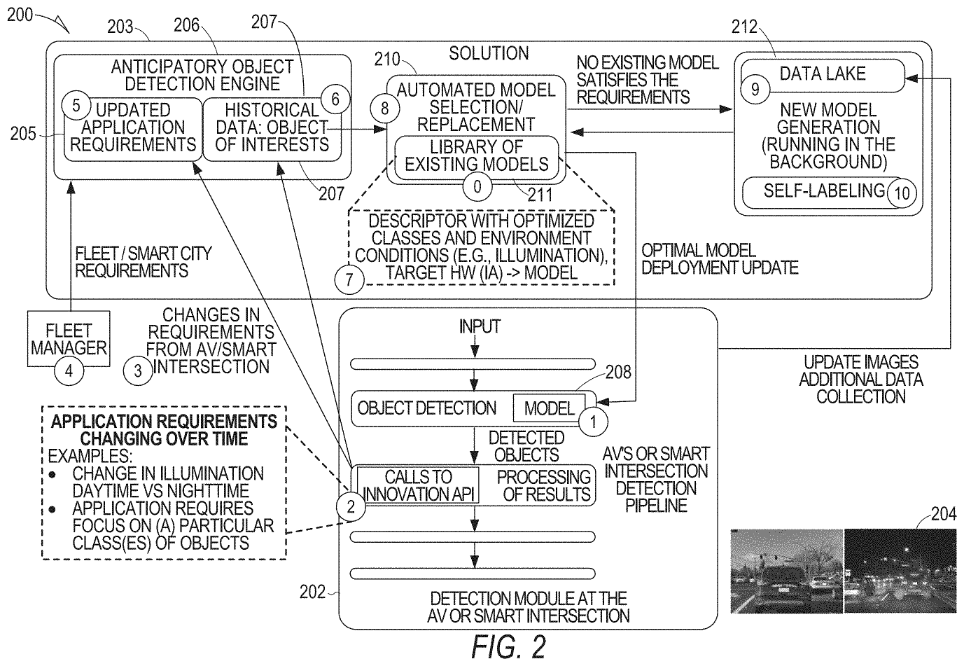

FIG. 2 shows an example architecture 200 implemented in one or more of the disclosed embodiments. FIG. 2 shows an object recognition client 202 analyzing images 204 of an environment. FIG. 2 shows that the object recognition client 202 interfaces with an anticipatory object recognition engine 206. The object recognition client 202 provides information relating to an environment of the object recognition client 202, objects being detected, and/or potential gaps in recognition capabilities of the object recognition client 202 based on an existing data model 208. The anticipatory object recognition engine 206 stores information received from the object recognition client 202. For example, the anticipatory object recognition engine 206 stores, requirements of the object recognition client 202 in an application requirements data store 205. Information relating to objects of interest of the object recognition client 202 are stored, in some embodiments, in an objects of interest data store 207.

The anticipatory object recognition engine 206 interfaces with a model selection module 210, which selects model data for the object recognition client 202 based on information provided by the anticipatory object recognition engine 206. In some embodiments, the model selection module 210 relies on a policy, π, which maps requirements and environmental conditions to models, i.e., π: [symbol] → [symbol] , where [symbol] is the set of requirements based on environmental conditions, target hardware, etc. and [symbol] is the set of models available to the system.

If the model selection module 210 identifies an existing model in the model library 211 that meets requirements, it obtains the model data from the model library 211 and provides it to the object recognition client 202. In some cases, if one or more indications/requirements from the object recognition client 202 do not map to an existing set of model data, some embodiments perform a “best fit” analysis to identify a set of model data in the model library 211 that is best adapted to the specified indications. These embodiments implement criterion determining if a “best fit” model is available. For example, some embodiments prioritize model data requirements and require the “best fit” to identify a model meeting at least a predefined highest priority set of requirements specified by an object recognition client. In some embodiments, requirements are assigned a type, with requirements of different types being assigned different weights. Some embodiments define that any “best fit” model must meet requirements specified by the object recognition client of a minimum total weight.

If no existing model is available (e.g. the “best fit” analysis does not find any existing model with a minimum “fit”, FIG. 2 shows that the model selection module 210 interfaces with a data lake 212 to obtain raw data as needed for training a model if no existing model satisfies requirements of an object recognition client. Once the model meeting the requirements of the object recognition client 202 has been trained, the model selection module 210 delivers the new model data to the object recognition client 202

Some embodiments collect data from the data lake 212 to build a dataset that is used to train a new model. In some embodiments, the new model is built to provide a better fit to the one or more indications discussed above than the model data identified via the “best fit” analysis.

An initial deployment of a model-based solution starts with a default model M₀. In some embodiments, Model M₀ is a model generalized to work well in most environments. In some embodiments, the model M₀ is selected based on one or more environmental indications and/or hardware configuration of the object recognition client 202.

As discussed above, in some embodiments, the object recognition client 202 provides information to the anticipatory object recognition engine 206 regarding conditions within an environment of the object recognition client 202 and/or information relating to a hardware configuration of the object recognition client 202.

Some examples of environmental conditions and requirements are shown below with respect to Table 1:

TABLE 1

| Environment | Classes of | | Target |
|---|---|---|---|
| Conditions | Objects | Efficiency | Hardware |
| Code | of Interest | Requirements | Code |
| Light intensity 260, | Cars, bikes, | Latency 30 ms., | 128 |
| overcast weather, | people | etc. | |
| clouds obscuring | | | |
| 85% of the sky, etc. | | | |
| Sunny weather, | Granular | Latency 25 ms., | 67 |
| clear sky, etc. | classification, e.g., | etc. | |
| | ambulances | | |
| . . . | . . . | . . . | . . . |

Embodiments use a variety of techniques to encode parameters and/or requirements received from the object recognition client 202. For example, hashing, one-hot encoding, integer encoding, or other custom encoding is utilized in a variety of different embodiments.

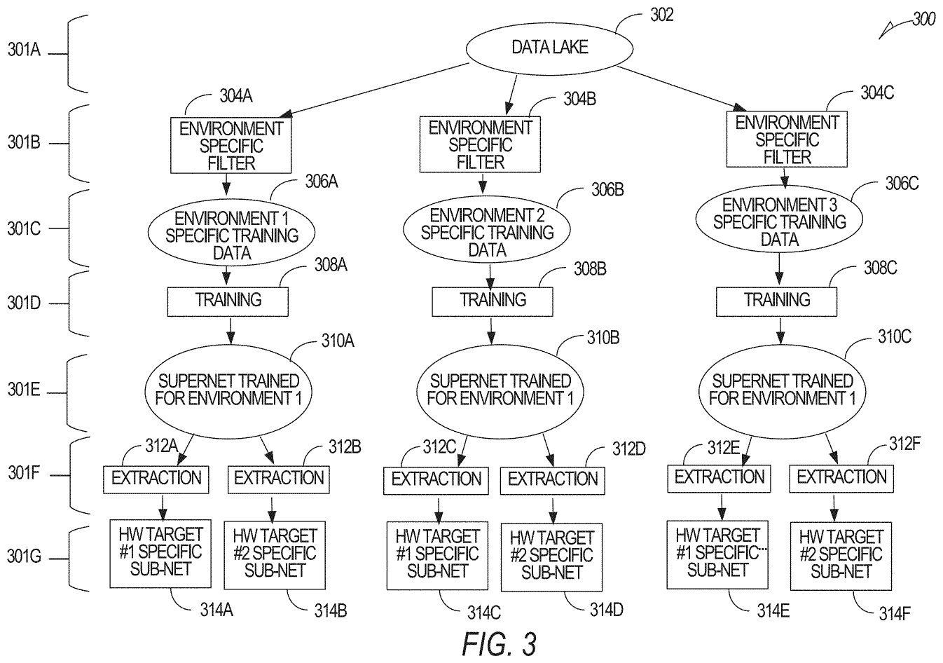

FIG. 3 shows an example data flow 300 implemented in one or more of the disclosed embodiments. The data flow 300 as shown begins in layer 301A with a data lake 302. The data lake is comprised of a variety of environmental data that is available to train machine learning models. In some embodiments, the environmental data includes data collected from vehicle sensors, and labels associated with the data. Thus, for example, the environmental data includes, in some embodiments, one or more of LIDAR data, RADAR data, imaging data. The environmental data also includes, in some embodiments, labels of objects detected in the data. The labels also indicate, in some embodiments, a type of object present in particular environmental data. Thus, for example, if the environmental data includes a LIDAR image of a bicyclist, that LIDAR image would be labeled as a bicyclist, at least in some embodiments.

Data included in the data lake 302 includes environmental data collected from environments having a variety of characteristics. For example, the data lake 302 includes, in some embodiments, environmental data collected during daylight hours and other environmental data collected during nighttime hours. Some of the environmental data is collected on sunny days while other environmental data is collected on cloudy days. These environmental characteristics of various portions of the data lake 302 are also indicated in the data lake 302. For example, portions of the data lake are tagged, in some embodiments, to identify environmental conditions under which the portions were collected. In some embodiments, the training data includes metadata, and the metadata is used to store tag information indicating environmental conditions under which the portions were collected.

FIG. 3 shows that within the second level 301B, environmental filters, such as an environmental filter 304A, environmental filter 304B, and environmental filter 304C are applied to data within the data lake 302 to generate, in layer 301C, training data specific to a first environment 306A, training data specific to a second environment 306B, and training data specific to a third environment 306C. Thus, for example, in some embodiments, the environmental filter 304A collects (e.g. via the tags discussed above, in some cases, tags stored in metadata) only training data captured or collected during a daylight environment (e.g. ambient light level above a threshold), while environmental filter 304B collects only training data captured or collected during a nighttime environment (e.g. ambient light below a threshold). FIG. 3 further shows that within a training level 301D, each of the environment training data specific to the first environment 306A, training data specific to the second environment 306B, and training data specific to the third environment 306C are used to train, via training component 308A, training component 308B, and training component 308C respectively, three super-nets, shown in level 301E as super-net 310A, which is trained on the training data specific to the first environment 306A, super-net 310B, which is trained on the training data specific to the second environment 306B, and super-net 310C, which is trained on training data specific to the third environment 306C. In some embodiments, the training performed in level 301D utilizes a method referred to as progressive shrinking that efficiently trains the super-nets, and the sub-nets derived from them.

A super-net is generally an overparameterized network, full network, or “largest” network. In other words, a network configured to run at a maximum or near maximum capacity. In some embodiments, a super-net is created by setting one or more configuration values of the super-net to their maximum possible respective values. For example, in some embodiments, a super-net is generated having a large kernel size, such as a maximum kernel size allowed by the super-net configuration, a large number of channels (e.g. a largest number of channels allowed by the super-net configuration, a maximum possible depth (e.g. layers in the network). In some embodiments, a super-net receives images having variable resolution as input.

Each of the super-nets 310A-C include model data trained via data associated with particular environmental characteristics. FIG. 3 further illustrates that those super-nets 310A-C are used as a source for generating hardware configuration specific sub-nets, via an extraction process in level 301F. FIG. 3 shows that each of extraction components 312A-F extract portions of the super-nets 310A-C to generate sub-nets (e.g. model data) specific to particular hardware environments, shown in FIG. 3 in layer 301G hardware specific sub-nets 314A-F. A sub-net generated by an extraction process shares a set of weights (adjustable and trainable parameters) with the overparameterized super-net from which it is derived.

While FIG. 3 provides an example that filters the data lake 302 via an environment specific filter, other types of filters are used in other embodiments. For example, in some embodiments, the data lake 302 is filtered by a type of object represented by the data. Thus, a plurality of super-nets are trained, in some embodiments, to detect different sets of objects. In some embodiments, the sets of objects overlap across multiple super-nets, while in other embodiments, the sets of objects are mutually exclusive. In these embodiments, a client indicates a set of objects it seeks to detect, and then an appropriate model is extracted from a super-net trained to detect at least that set of objects.

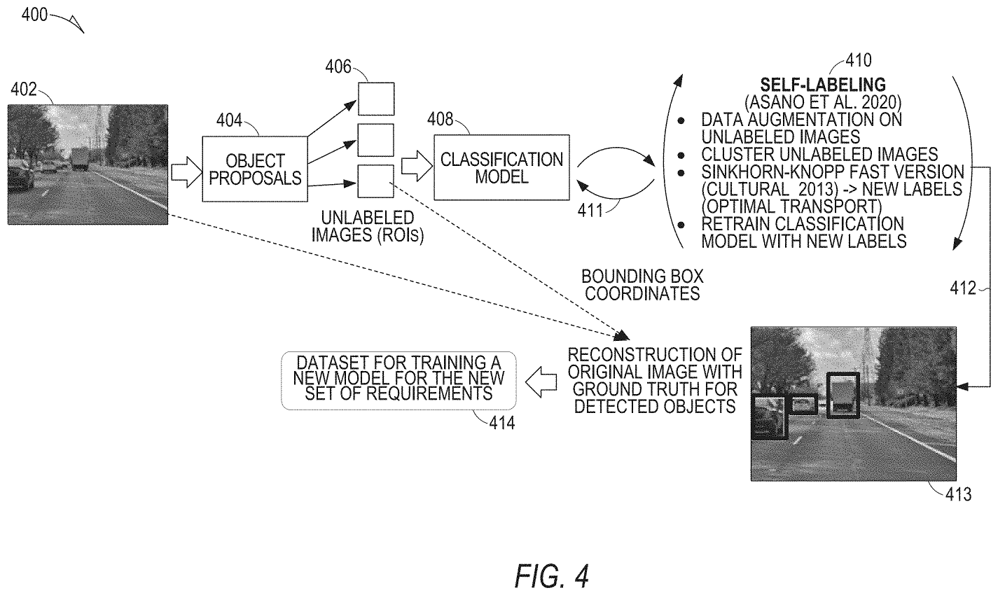

FIG. 4 is a data flow diagram showing a self-labeling pipeline 400 implemented in some of the disclosed embodiments. The self-labeling pipeline 400 shows an original image 402 analyzed by an object proposal method 404. The object proposal method 404 generates unlabeled regions of interest in images 406, which are provided to a classification model 408. In some embodiments, the self-labeling pipeline 400 applies self-labeling 410 to the unlabeled regions of interest in the images 406. In some embodiments, the self-labeling 410 utilizes a Sinkhorn-Knopp method and simultaneous clustering and representation methods. Results 411 of the self-labeled images are used to train the classification model 408 Based on the object proposals (bounding boxes) and the trained classification model, and the labeled regions 412, training data 413 of the original image is generated that includes ground truth of detected objects. The training data 413 is added to a dataset 414 for training a new model.

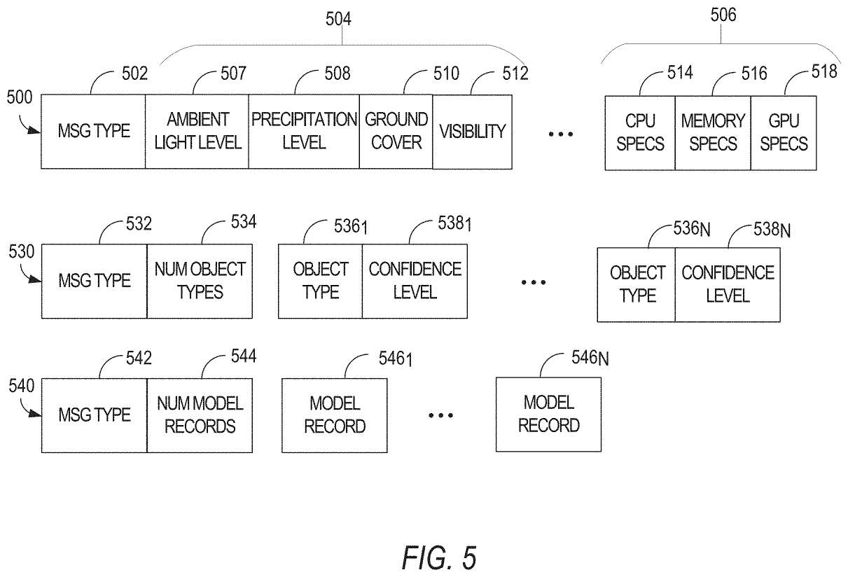

FIG. 5 shows example message portions implemented in one or more of the disclosed embodiments. FIG. 5 shows a first message portion 500, a second message portion 530, and a third message portion 540. The first message portion 500 is transmitted, in some embodiments, from an object recognition client, to a deployment server. The illustrated first message portion 500 includes a message type field 502, one or more environmental indications 504 and one or more hardware indications 506. The environmental indications 504 include an ambient light level field 507, precipitation level field 508, ground cover field 510, or a visibility field 512. The hardware indications 506 include a CPU specifications field 514, memory specifications field 516, and GPU specifications field 518. Some embodiments of the first message portion 500 further include one or more fields to indicate one or more of a latency condition or criterion of the object recognition client, power consumption condition or criterion of the object recognition client, throughput condition or criterion of the object recognition client, a CPU utilization condition of the object recognition client, or an input/output (I/O) bandwidth utilization condition of the object recognition client. Some embodiments of the model deployment system 203 identify a set of model data to provide to an object recognition client 202 based on one or more fields of the first message portion 500.

The second message portion 530 includes a message type field 532, a number of object types field 534, and repeating pairs of fields, each pair including an object type field (shown as object type fields 536_{1 . . . n}) and a confidence level field (shown as confidence level fields 538_{1 . . . n}). The message type field 532 identifies, in some embodiments, via a predefined constant, the format of the second message portion 530 as illustrated in FIG. 5. The number of object types field 534 communicates a number of object types described by the second message portion 530. The number of object types field 534 indicates a number of field pairs that follow the number of object types field 534. Each field of the pair defines an object type (via object type field 536_{1 . . . n}) and a confidence level field (via confidence level fields 538_{1 . . . n}). In some embodiments, the model deployment system 203 uses the object types specified in the second message portion 530 to select a set of model data appropriate for an object recognition client 202 providing the second message portion 530.

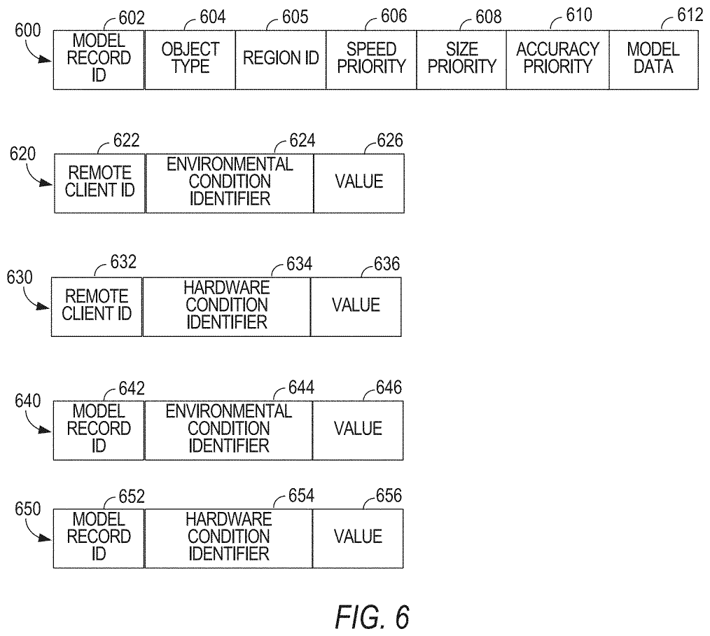

The third message portion 540 includes a message type field 542, a number of model records field 544, and then a variable number of model records fields, identified as fields 546₁ to 546ₙ. In some embodiments, a model deployment system 203 utilizes a message including data analogous to data of the third message portion 540 to provide model data to an object recognition client 202. The number of model records field 544 indicates a number of model records included in the message, and the model record fields 5461-546n provide the model data. In some embodiments, the model data provided by the third message portion 540 is derived from the model data record table 600, discussed below with respect to FIG. 6 (e.g., the model data field 612).

FIG. 6 shows example data structures implemented in one or more of the disclosed embodiments. While the example data structure of FIG. 6 is illustrated and discussed below as relational database tables, the disclosed embodiments contemplate the use of a variety of data architectures, and are not limited to the examples of FIG. 6.

FIG. 6 shows a model data record table 600, a client environmental conditions table 620, a client hardware conditions table 630, a model record environmental conditions table 640, and a model record hardware conditions table 650.

The model data record table 600 includes a model record identifier field 602, object type field 604, region identifier field 605, speed priority field 606, size priority field 608, accuracy priority field 610, and model data field 612. The object type field 604 identifies one or more object types whose recognition can be improved based on the model record defined in the model record identifier field 602. Thus, in some embodiments, an object recognition client 202 requests model data to assist it with recognizing a particular set of one or more objects. In these embodiments, the object type field 604 can assist a model deployment system 203 in identifying which model data records to provide to the requesting object recognition client 202.

The region identifier field 605 identifies one or more regions (e.g., via coordinate values, latitude/longitude values, etc.) for which the model data field 612 is applicable. For example, some embodiments provide region specific models to object recognition clients to assist with reducing a size of model data provided to the client and also possibly reducing latency. In these embodiments, the region identifier field 605 assists a model deployment system 203 in identifying which model record data (e.g., model data field 612) to provide to a requesting object recognition client 202. The speed priority field 606 indicates a priority of a particular model data record with respect to improved latency and performance of an object recognition model. Thus, some embodiments prioritize inclusion of model data records to meet speed requirements or constraints specified by an object recognition client 202. A size priority field 608 indicates a priority of a particular model data record with respect to reduction in memory footprint of an object recognition model. Thus, some embodiments prioritize inclusion of model data records to meet memory size requirements or constraints specified by an object recognition client 202.

The accuracy priority field 610 indicates a priority of particular model data record with respect to improving accuracy of object recognition. Thus, in some embodiments, model data records providing large accuracy contributions are prioritized more highly than other model data records providing a relatively smaller object recognition contribution.

The client environmental conditions table 620 include a remote client identifier field 622, environmental condition identifier field 624, and a value field 626. The remote client identifier field 622 uniquely identifies a remote client device, such as the object recognition client 202 discussed above with respect to FIG. 2. The environmental condition identifier field 624 uniquely identifies a particular environmental condition, such as an ambient light level, precipitation level, ground cover, visibility, humidity, or other environmental condition. The value field 626 identifies a value of the environmental condition. Thus, for example, if the environmental condition identifier field 624 identifies a precipitation level, the value field 626 indicates whether there is no precipitation, light rain, light snow, or heavy rain, as an example.

The client hardware conditions table 630 includes a remote client identifier field 632, client hardware condition identifier field 634, and a value field 636. The remote client identifier field 632 uniquely identifies a remote client, such as the object recognition client 202. The client hardware condition identifier field 634 identifies a particular hardware condition, such as a CPU speed, cache size, memory size, memory speed, stable storage space available, stable storage latency, graphical processing capability, or other hardware condition. The value field 636 identifies a value associated with the identified hardware condition of the client hardware condition identifier field 634. Thus, for example, if the identified hardware condition is a memory size, the value field indicates, in some embodiments a number of megabytes of memory available for use at the remote client.

The model record environmental conditions table 640 includes an environmental condition identifier field 644 and a value field 646. The model record identifier field 642 uniquely identifies a record of model data, and is cross referenceable with the model record identifier field 602. The environmental condition identifier field identifies an environmental condition, in a similar manner to the environmental condition identifier field 624 discussed above. The value field 646 identifies a value of the identified environmental condition, in a similar manner to the value field 626 discussed above. In some embodiments, the model record environmental conditions table 640 is used to identify a set of model records appropriate for a given environmental condition. Thus, for example, in some embodiments, the model deployment system 203 searches the model record environmental conditions table 640 to identify model records appropriate for nighttime object recognition environmental condition identifier field 644 identifying an illumination level environmental condition, and the value field 646 identifying a nighttime or relatively lower level of illumination. Any such record found in the model record environmental conditions table 640 are records appropriate for use at nighttime.

The model record hardware conditions table 650 includes a hardware condition identifier field 654 and a value field 656. The model record identifier field 652 uniquely identifies a record of model data, and is cross referenceable with the model record identifier field 602. The hardware condition identifier field identifies a hardware condition, in a similar manner to the client hardware condition identifier field 634 discussed above. The value field 656 identifies a value of the identified hardware condition, in a similar manner to the value field 636 discussed above. In some embodiments, the model record hardware conditions table 650 is used to identify a set of model records appropriate for a given hardware condition. Thus, for example, in some embodiments, the model deployment system 203 searches the model record hardware conditions table 650 to identify model records appropriate for an object recognition client 202 having a relatively slow CPU speed (e.g., hardware condition identifier field 654 identifying a CPU speed as the hardware condition, and the value field 656 identifying a specific CPU speed or CPU speed class. Any such record found in the model record hardware conditions table 650 is a record appropriate for use on object recognition clients having the indicated CPU speed.

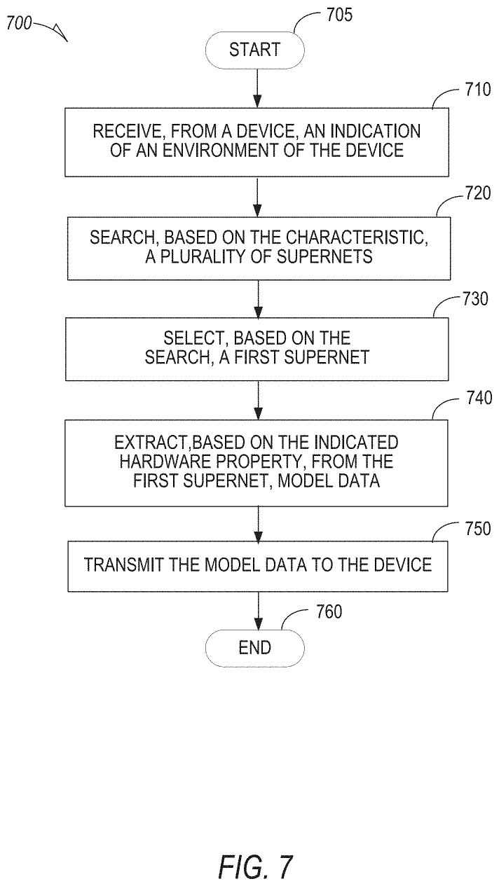

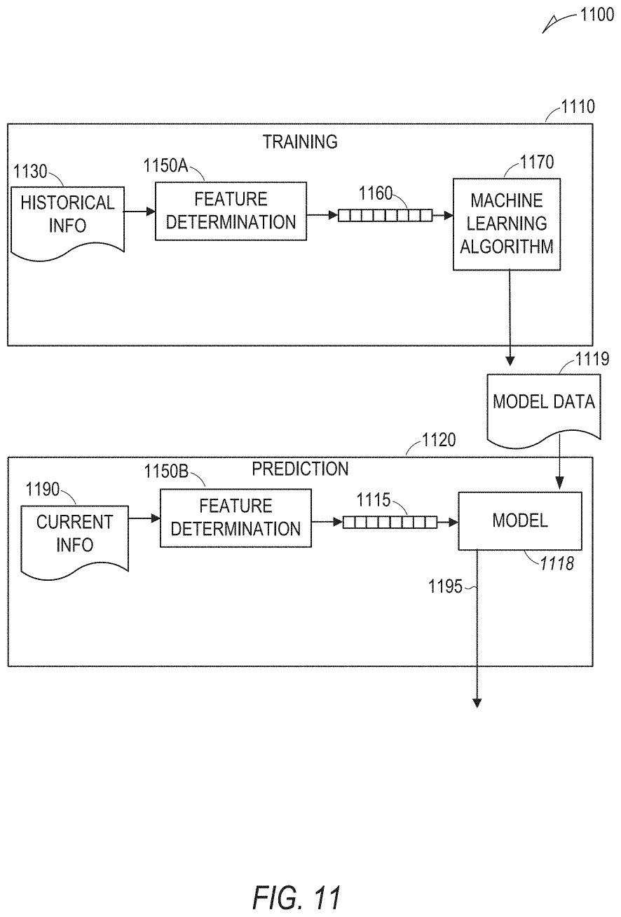

FIG. 7 is a flowchart of a method for providing model data to an object recognition client device. An example of model data is illustrated below as model data 1119 discussed with respect to FIG. 11. In some embodiments, one or more of the functions discussed below with respect to FIG. 7 is performed via hardware processing circuitry. For example, in some embodiments, hardware processing circuitry (e.g., the hardware processor 1202 discussed below) is configured by instructions (e.g., 1224 discussed below) stored in a memory (e.g. memory 1204 and/or 1206 discussed below) to perform one or more of the functions discussed below with respect to FIG. 7 and/or the method 700. In some embodiments, the model deployment system 203 performs one or more of the functions discussed below with respect to FIG. 7 and the method 700. In the discussion below of FIG. 7, a device performing one or more of the functions of the method 700 is described as an “executing device.”

After start operation 705, method 700 moves to operation 710, which receives, from a device, an indication of one or more characteristics of an environment of the device. The environment of the device includes, in some embodiments, one or more of an external environment proximate to the device, and an internal environment or hardware configuration of the device itself. The external environment is an environment in which the device performs object recognition. For example, as discussed above, some of the disclosed embodiments utilize one or more types of environmental sensors, such as imaging sensors, LIDAR sensors, or RADAR sensors, to sense the environment and recognize objects and their types in the environment.

The characteristics of the environment include, in various embodiments, a level of precipitation occurring within the environment, an ambient light level in the environment, a ground cover in the environment (e.g., snow, hail, concrete, asphalt, grass, foliage, water, or other ground cover), a visibility of the environment (e.g., ten meters, 50 meters, unlimited, etc.), or any other environmental condition, such as a weather condition of the environment. Other examples of characteristics include whether the environment is a daytime environment (e.g. ambient light level above a threshold), nighttime environment (ambient light level below a threshold), cloudy day, foggy conditions, bright sunny day, or other lighting conditions. In some embodiments, a location of the device is indicated. In some embodiments, a movement of the device is indicated. For example, in some embodiments, the indication indicates a velocity vector of the device (e.g., speed and direction).

A hardware property, configuration or internal environment of the device indication received in operation 710 indicates, in some embodiments, one or more of a hardware processor configuration of the device (e.g. a model and/or serial number of the device, how many and/or what type of hardware processors, their relative speeds, cache sizes, or other characteristics indicating performance of the processors). Some embodiments of operation 710 receive a message analogous to the first message portion 500 discussed above with respect to FIG. 5. The indication(s) of environmental conditions of the device are then decoded from one or more fields of the message. Some embodiments store the received indications in a data store, such as the application requirements data store 205, discussed above. The stored indications are then used, for example to determine additional groupings of model data to support object recognition clients.

In some embodiments, operation 710 includes receiving indications of one or more object types from the device. In some embodiments, the object types indicate objects the device attempts to recognize within its environment. The indication of object types indicates, in some embodiments, object types within an environment (e.g., objects of interest) of the device that the device attempts to recognize using model data (e.g., by analyzing image sensor data). In some embodiments, confidence levels obtained by the device are also provided in the received indications (e.g., via data analogous to any one or more fields of the second message portion 530 in some embodiments).

In some embodiments, one or more indications of constraints of the device are received in operation 710. For example, in some embodiments, the device provides an indication of a latency or throughput criterion or current condition of the device.

In some embodiments, a region in which the object recognition client 202 is operating is received in operation 710.

In operation 720, a plurality of super-nets are evaluated or searched based on the characteristic of the environment. For example, as described above with respect to FIG. 3, some embodiments generate a plurality of super-nets (e.g. 310a-C), with each super-net trained during training data that is specific to particular environmental conditions or characteristics (e.g. training data 306A-C). Operation 720 identifies a super-net having characteristics matching those of the environmental characteristics indicated by the device in operation 710. In some embodiments, operation 720 searches data analogous to the model record environmental conditions table to identify model data associated with a super-net that is compatible with environmental characteristics or conditions indicated by the device in operation 710.

In operation 730, a first super-net is selected based on the search of operation 720. In other words, the first super-net is a super-net trained under conditions matching or best matching those characteristics indicated by the object detection client in operation 710.

In operation 740, a sub-net is extracted from the selected super-net based on the specified hardware characteristics. In some embodiments, a subset of weights defined by the super-net are extracted from the super-net and used to build or extract model data. Thus, the resulting model data defines a smaller network with a subset of weights included in the super-net from which it is derived. The weights extracted are selected based on the hardware target configuration of the device. In some embodiments, weights within a super-net are prioritized, and the extraction of weights from the super-net to generate the model data is based on the priorities. Other attributes of the super-net are also prioritized in some embodiments. For example, channels, kernel components, blocks, or other super-net components are prioritized, and then the extraction of these components to generate the model data proceeds in priority order of the component.

In some embodiments, extracting model data from the selected super-net includes searching a datastore of super-net model data, analogous, in some embodiments, to the model data record table 600, discussed above with respect to FIG. 6, to identify model data appropriate for the requesting object recognition client 202. For example, as discussed above, some embodiments consult data analogous to the model record environmental conditions table 640 and/or the model record hardware conditions table 650 to identify model records compatible with environmental and/or hardware conditions at an object recognition client 202. In these embodiments, the identified model data is then obtained from a datastore analogous to the model data record table 600, discussed above with respect to FIG. 6.

In some embodiments, model data satisfying all of the constraints or requirements of the device as received in operation 710 cannot be identified. For example, the device indicates, in some embodiments, it seeks to recognize objects of a particular type, but data super-net necessary to provide an acceptable accuracy of recognition exceeds a memory size also indicated by the device. When encountering such a condition, some embodiments identify a best fit set of model data to provide to the device. For example, in some embodiments, requirements or indications provided by the device are prioritized, either by a device performing the method 700 or by the remote device itself For example, in some embodiments, data analogous to the first message portion 500 indicates priorities of the indications provided in the message portion. In some embodiments, data analogous to the second message portion 530 indicates a priority of each of the indicated object types. The executing device applies these priorities to identify model data satisfying as many of the highest priority constraints or indications as possible given available model data. Thus, some embodiments of the executing device determine a best fit between available model data and the environment and/or constraints and/or requirements of the requesting device.

In some other embodiments, model data itself is prioritized based on one or more factors. For example, as illustrated above with respect to FIG. 6, the example model data record table 600 shows each model record indicating a priority with respect to speed (e.g. latency constraints of the requesting device), space (e.g. to fit within an available memory of the requesting device), accuracy (e.g. precision in object recognition). These are provided as just examples and indications of other priorities are contemplated by the disclosed embodiments and are not limited to the examples of FIG. 6. Thus, in some circumstances, the executing device identifies model data based on one or more priorities associated with model data records or portions, and builds a set of model data for delivery to the requesting device based on the priority, until the collected set of model data reaches a limit identified by the requesting device (e.g., until the collected model data would violate a requirement or constraint indicted by the requesting device).

Some embodiments identify a super-net based on a region in which the requesting device is operating. As discussed above, some requesting devices provide this information when requesting model data. The model deployment system 203 then identifies an appropriate super-net data based on the supplied region information (e.g., via data analogous to region identifier field 605 discussed above with respect to FIG. 6).

In operation 750, the extracted model data is provided to the requesting device of operation 710. For example, as discussed above with respect to FIG. 5, some embodiments transmit a message including data analogous to one or more fields of the example third message portion 540 to provide data from a model deployment system (e.g., model deployment system 203) to an object recognition client (e.g. object recognition client 202).

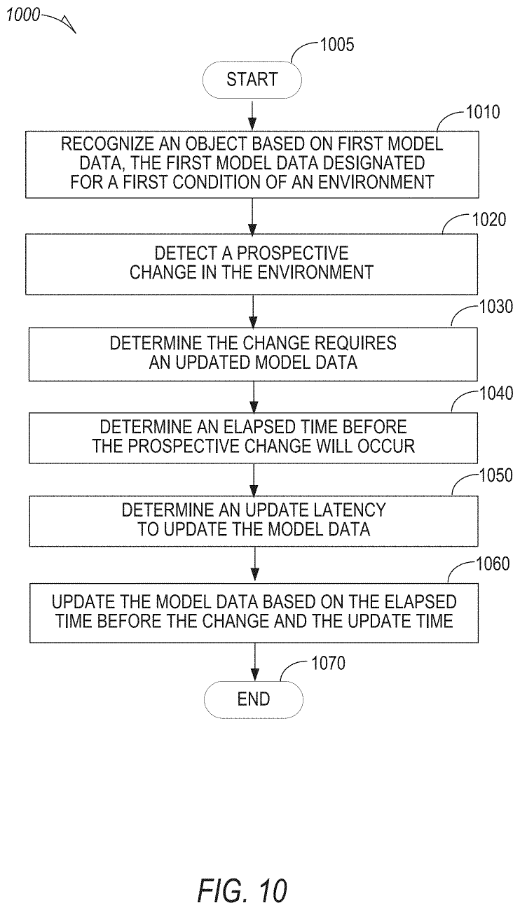

After operation 750 completes, method 700 moves to end operation 760. Some embodiments of method 700 include one or more of the functions discussed below with respect to FIG. 10.

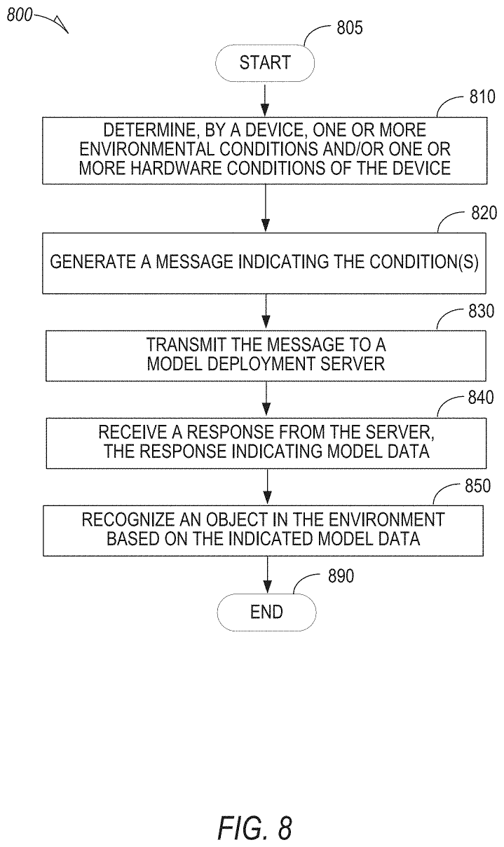

FIG. 8 is a flowchart of a method for obtaining model data. An example of model data is illustrated below as model data 1119 discussed with respect to FIG. 11. In some embodiments, one or more of the functions discussed below with respect to FIG. 8 is performed via hardware processing circuitry. For example, in some embodiments, hardware processing circuitry (e.g., the hardware processor 1202 discussed below) is configured by instructions (e.g., 1224 discussed below) stored in a memory (e.g. memory 1204 and/or 1206 discussed below) to perform one or more of the functions discussed below with respect to FIG. 8 and/or the method 800. In some embodiments, the object recognition client 202 performs one or more of the functions discussed below with respect to FIG. 8 and method 800. In the discussion below of FIG. 8, a device performing one or more of the functions of method 800 is described as an “executing device.”

After start operation 805, method 800 moves to operation 810, where a device determines one or more environmental conditions and/or one or more hardware conditions of the device. In some embodiments, the device is running an object recognition client 202. For example, as discussed above, in some embodiments, an object recognition client 202 includes one or more environmental sensors, such as one or more imaging sensors, LIDAR sensors, microphones, ultrasonic sensors, infrared sensors, radar sensors, or other sensors. From data collected from these sensor(s), the device determines one or more characteristics of its environment, such as an ambient light level, sound level, visibility, humidity, velocity, direction, ground coverage, weather conditions (raining, clear skies, snowing, sleeting), wind speed, or other condition.

In some embodiments, the device determines one or more hardware configuration parameters or other hardware conditions of the device itself. For example, the device determines CPUS characteristics (speed, model, cache size, etc.), memory characteristics (latency, size), stable storage characteristics (total size, free space, throughput, latency), or other characteristics.

In operation 820, a message is generated indicating the conditions determined in operation 820. In some embodiments, the generated message includes data analogous to any one or more of the fields discussed above with respect to the first message portion 500 and/or the second message portion 530 of FIG. 5.

In operation 830, the message is transmitted to a model deployment system 203. The use of the term “model deployment system” is not intended to be limiting, but instead provided to facilitate explanation of the disclosed embodiments. Given the use of cloud-based computing environments in many modern implementations, some embodiments have little control over which particular hardware “system” receives and/or processes a network message. Instead, the message is transmitted to an address (e.g., IP address) associated with a hostname (e.g. typically via the domain name system). For notational convenience, the destination of the message is referred to as a model deployment system but can be any hardware that receives the transmitted message.

In operation 840, a response is received from the model deployment system. In some embodiments, the response includes data analogous to data described above with respect to the third message portion 540. The response includes model data used by an object recognition system to recognize one or more objects. For example, in some embodiments, the model data represents convolutional neural network data, such as data indicating filter responses to input data. Other embodiments use other types of model data.

In operation 850, an object within an environment is recognized based on the model data. As discussed above, some embodiments of an object recognition client 202 include one or more sensors to sense at least one aspect of an environment proximate to the object recognition client 202. Data from the sensor(s) is applied against the model data to identify one or more objects within the environment. As discussed above, in some embodiments, the model data represents a convolutional neural network that has been trained to recognize a set of one or more objects. As also discussed above, in some embodiments, separate sets of model data are provided to object recognition clients based on one or more characteristics of the client's environment. For example, some embodiments provide different model data depending on whether the object recognition client 202 is operating in a daytime or nighttime environment. Different models are also provided, in some embodiments, based on one or more weather conditions in the environment. For example, cloudy environments call for a different model than sunny environments in some embodiments. As also discussed above, some embodiments customize model data for particular computing resource environments, constraints, or requirements. Therefore, in these embodiments, object recognition clients having constrained memory resources receive smaller sets of model data, which may provide less accurate object recognition as a result, when compared to other object recognition clients without such memory constraints.

After operation 850 is completes, method 800 moves to end operation 890.

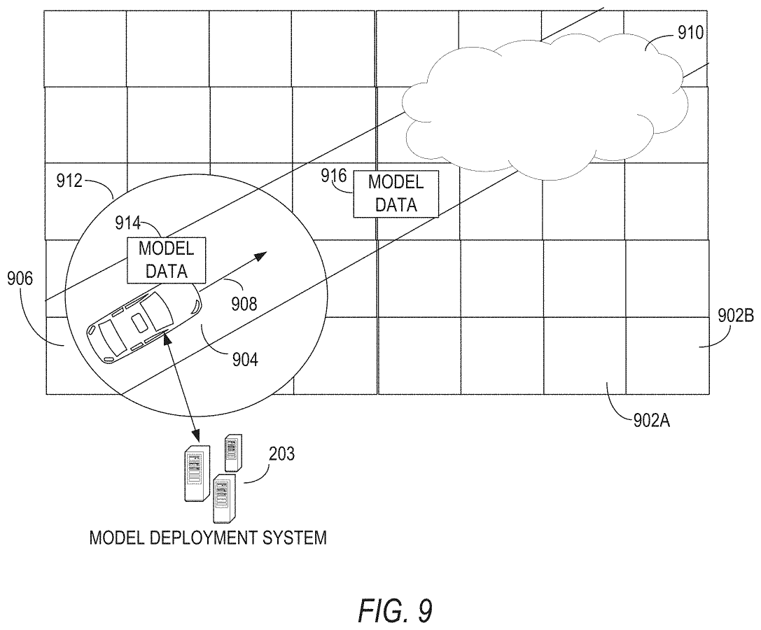

FIG. 9 illustrates a method of anticipatory model data deployment. An example of model data is illustrated below as model data 1119 discussed with respect to FIG. 11. FIG. 9 shows a plurality of regions. Two regions are shown as region 902A and region 902B. Other regions are not individually identified to preserve figure clarity. A vehicles 904 is driving through the regions. The vehicle is driving on a road 906 in a direction 908, toward an area of fog 910. The vehicles 904 is in communication with a model deployment system 203, such as the model deployment system 203 discussed above with respect to FIG. 2.

The vehicles 904 is operating in the area 912 based on model data 914, which is appropriate for the area 912. The model data 914 is appropriate for the area 912 for a variety of different reasons in different embodiments. For example, the model data 914 is appropriate for the area 912 in some embodiments, because the model data 914 is designated for use in the area 912 (e.g., based on data analogous to the region identifier field 605 in some embodiments, Alternatively, or in combination, the model data 914 is appropriate for the area 912 based on current environmental conditions in the area 912. For example, it may be daytime in the area 912, and the model data 914 is designated for use during daytime conditions.

Before the vehicles 904 reaches the area of fog 910, the vehicle will need, in the illustrated embodiment, an updated model data 916, at the location shown, in order to successfully perform object recognition within the area of fog 910. For example, the updated model data 916 is designated for use in environmental conditions consistent with the area of fog 910, whereas the model data 914 is not designated for use under those conditions. Alternatively, some embodiments score different model data under various conditions, and thus, model data 914 may simply have a lower score in conditions present in the area of fog 910 relative to a score of updated model data 916.

Some of the disclosed embodiments anticipate when an object recognition client 202, such as the vehicles 904, requires updated model data (e.g., updated model data 916) to adequately perform object recognition in a new environment (such as the area of fog 910). The flowchart of FIG. 10 describes an example embodiment of anticipating a need for updated model data.

FIG. 10 is a flowchart of an example method of providing updated model data. An example of model data is illustrated below as model data 1119 discussed with respect to FIG. 11. In some embodiments, one or more of the functions discussed below with respect to FIG. 10 is performed via hardware processing circuitry. For example, in some embodiments, hardware processing circuitry (e.g., the hardware processor 1202 discussed below) is configured by instructions (e.g. 1224 discussed below) stored in a memory (e.g. memory 1204 and/or 1206 discussed below) to perform one or more of the functions discussed below with respect to FIG. 10 and/or the method 1000. In some embodiments, the object recognition client 202 performs one or more of the functions discussed below with respect to FIG. 10 and method 1000. In the discussion below of FIG. 10, a device performing one or more of the functions of method 1000 is described as an “executing device.” In some embodiments, an object recognition client 202 performs the method 1000. In some embodiments, a model deployment system 203 performs the method 1000.

After start operation 1005, method 1000 moves to operation 1010, which recognizes an object based on first model data. An example of model data is illustrated below as model data 1119 discussed with respect to FIG. 11. The first model data is designated for a first condition of an environment. For example, as discussed above, in various embodiments, particular model data is designated for use under certain environmental conditions (e.g., via the model record environmental conditions table 640) and/or hardware conditions (e.g. via the model record hardware conditions table 650. The first condition is, in some embodiments, daytime, clear skies, when raining, when foggy, when snowing or any other environmental condition. For example, as discussed above with the example of FIG. 9, the vehicles 904 is within the area 912 which has a first set of environmental conditions and then eventually enters the area of fog 910, which has a different set of environmental conditions.

In operation 1020, a prospective change in the environment is detected. In some embodiments, the prospective change is detected based on a movement of the object recognition client 202. For example, some embodiments of operation 1020 determine a speed and direction of the object recognition client 202. When method 1000 is performed by the model deployment system 203, the object recognition client 202 sends, in some embodiments, messages to the model deployment system 203 indicating its speed, direction, and/or current position. The model deployment system 203 then determines whether any regions within a predicted or defined path of the object recognition region indicate updated model data is more appropriate than a set of model data in use by the object recognition client 202. For example, in some embodiments, the model deployment system 203 determines environmental conditions present along the predicted or defined path. For example, some embodiments determine forecast weather conditions along a predicted path of the object recognition client. Model data developed based on training data similar to the forecast weather conditions is then provided to the object recognition client 202 in some embodiments (e.g. predicted cloudy weather results in the object recognition client 202. receiving model data resulting from training data from cloudy days, predicted sunny weather result in the object recognition client 202 receiving, in some embodiments, model data developed from training data collected during sunny weather. In some embodiments, a time the object recognition client is expected to be in a predicted region is also used to select model data for the object recognition client. For example, if the object recognition client is predicted to be in a region during nighttime hours, model data resulting from training data collected during nighttime hours is provided to the object detection client.

When operation 1020 is performed by the object recognition client 202 itself, the object recognition client 202 determines its own speed and direction, and consults on-board or off board resources to determine whether its existing model data is appropriate for regions it will soon visit.

In operation 1030, a determination is made that the change in the environment requires updated model data. Thus, in some embodiments, a prediction is made that updated model data is needed prospectively, based on circumstances of the object recognition client 202. In some embodiments, a new location of the object recognition client 202 is predicted, and needs or requirements of the new location are assessed to determine whether the object recognition client's existing model data is sufficient to operate in the new location or if an update is preferred (e.g. are the environmental conditions of the predicted region at the time the object recognition client will be within the predicted region compatible with the client's existing set of model data).

In operation 1040, an elapsed time before the prospective change will occur is determined. Thus, for example, in the illustrated embodiment of FIG. 9, an amount of time until the vehicles 904 reaches the area of fog 910 is determined. This determination is based, in some embodiments, on one or more of a velocity, direction of the object recognition client 202, and a distance from the object recognition client's current position to a position that needs the updated model data.

In operation 1050, a latency in updating the model update is determined. Some embodiments determine, for example, a network latency and/or throughput between the object recognition client 202 and the model deployment system 201 Some embodiments, further determine, a size of the updated model data. Some embodiments also determine a latency between a time that the updated model data is received by the object recognition client 202 and the object recognition client 202 begins using the updated model data to perform object recognition. Some embodiments further determine a latency of a model deployment system 203 to prepare the updated model data and initiate transmission of the updated model data to the object recognition client 202. The latency to update is then determined based on one or more of these factors.

In operation 1060, the model is updated based on the elapsed time of operation 1040 and/or the update latency. For example, in some embodiments, the update latency is subtracted from the elapsed time, and the update is initiated after the resulting elapsed time. In some embodiments, the update is initiated after the resulting elapsed time, after adding a margin constant to the subtraction. If the object recognition client 202 performs the method 1000, then updating the model data includes requesting the model data from the model deployment system 203, and receiving the updated model data from the model deployment system 203 (e.g. via a message including data analogous to one or more fields of the third message portion 540, discussed above with respect to FIG. 5. If operation 1060 is performed by the model deployment system 203, updating the model data include transmitting a message to the object recognition client 202 indicating the updated model data. This includes, in some embodiments, transmitting a message including data analogous to one or more fields of the third message portion 540 discussed above with respect to FIG. 5.

After operation 1060 completes, method 1000 moves to end operation 1070.

FIG. 11 shows an example machine learning module 1100 according to some examples of the present disclosure. Machine learning module 1100 utilizes a training module 1110 and a prediction module 1120. Training module 1110 inputs historical information 1130 into feature determination module 1150A. The historical information 1130 may be labeled. Example historical information may include imaging data, such as snapshot images and/or video data of an environment proximate to an object recognition client. This historical information is stored in a training library in some embodiments. Labels included in the training library indicate in some embodiments, a type of object recognized in the historical information 1130.

Feature determination module 1150A determines one or more features 1160 from this historical information 1130. Stated generally, features 1160 are a set of the information input and are determined to be predictive of a particular outcome. In some examples, the features 1160 may be all the historical information 1130, but in other examples, the features 1160 are a subset of the historical information 1130. The machine learning algorithm 1170 produces model data 1119 based upon the features 1160 and the labels. In some embodiments, for example, those embodiments that utilize a neural network, the model data 1119 defines a configuration of the neural network architecture and any adjustable parameter values of the neutral network.

In the prediction module 1120, current information 1190 may be input to the feature determination module 1150B. The current information 1190 in the disclosed embodiments include similar indications of that described above with respect to the historical information 1130. How-ever, the current information 1190 provides these indications for relatively recently observed sensor data (e.g. within a previous one, two, five, ten, thirty, or sixty minute time period).

Feature determination module 1150E determines, in some embodiments, an equivalent set of features or a different set of features from the current information 1190 as feature determination module 1150A determined from historical information 1130. In some examples, feature determination module 1150A and 1150B are the same module. Feature determination module 1150B produces features 1115, which is input into the model 1118 to generate a one or more predictions of sensor data during a prospective time period. The model 1118 relies on model data 1119 which stores results of the training performed by the training module 1110. The training module 1110 may operate in an offline manner to train the model 1118. The prediction module 1120, however, may be designed to operate in an online manner. It should be noted that the model 1118 may be periodically updated via additional training and/or user feedback.

The prediction module 1120 generates one or more outputs 1195. The outputs include, in some embodiments, types of objects represented by the current information 1190.

The machine learning algorithm 1170 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, linear classifiers, quadratic classifiers, k-nearest neighbor, linear regression, logistic regression, hidden Markov models, models based on artificial life, simulated annealing, and/or virology. Examples of unsupervised learning algorithms include expectation-maximization algorithms, vector quantization, and information bottleneck method. Unsupervised models may not have a training module 1110. In an example embodiment, a regression model is used and the model 1118 is a vector of coefficients corresponding to a learned importance for each of the features in the vector of features 1160, 1115. In some embodiments, to calculate a score, a dot product of the features 1115 and the vector of coefficients of the model 1118 is taken.

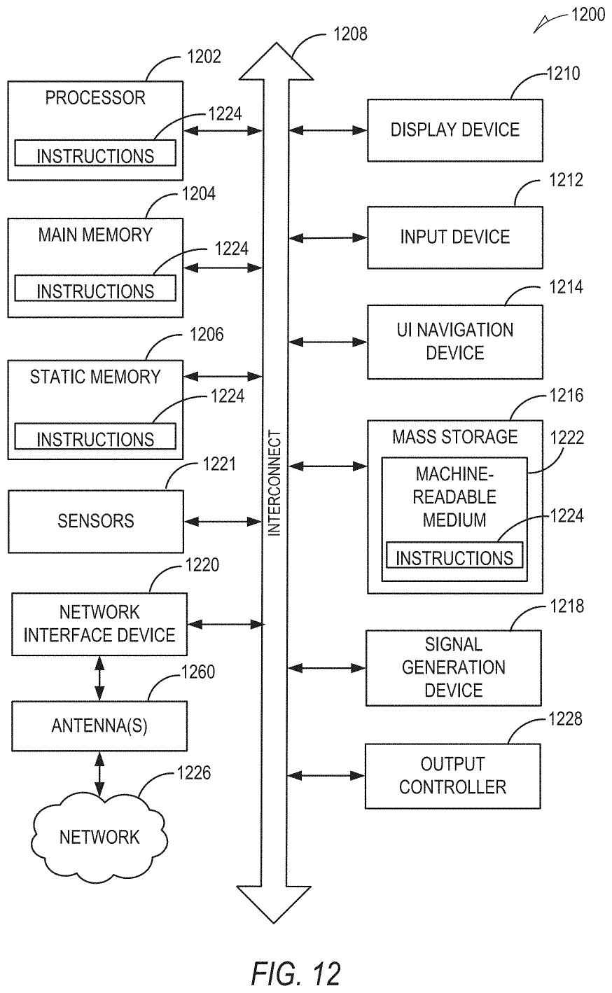

FIG. 12 illustrates a block diagram of an example machine 1200 upon which any one or more of the techniques (e.g., methodologies) discussed herein may perform. Machine (e.g., computer system) 1200 may include a hardware processor 1202 (e.g., a central processing unit (CPU), a graphics processing unit (GPU), a hardware processor core, or any combination thereof), a main memory 1204 and a static memory 1206, some or all of which may communicate with each other via an interlink 1208 (e.g., bus). In some embodiments, the example machine 1200 is implemented by the model deployment system 203.

Specific examples of main memory 1204 include Random Access Memory (RAM), and semiconductor memory devices, which may include, in some embodiments, storage locations in semiconductors such as registers. Specific examples of static memory 1206 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 1200 may further include a display device 1210, an input device 1212 (e.g., a keyboard), and a user interface (UI) navigation device 1214 (e.g., a mouse). In an example, the display device 1210, input device 1212 and UI navigation device 1214 may be a touch screen display. The machine 1200 may additionally include a mass storage device 1216 (e.g., drive unit), a signal generation device 1218 (e.g., a speaker), a network interface device 1220, and one or more sensors 1221, such as a global positioning system (GPS) sensor, compass, accelerometer, or some other sensor. The machine 1200 may include an output controller 1228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the hardware processor 1202. and/or instructions 1224 may comprise processing circuitry and/or transceiver circuitry.

The mass storage device 1216 may include a machine readable medium 1222 on which is stored one or more sets of data structures or instructions 1224 (e.g., software) embodying or utilized by any one or more of the techniques or functions described herein. The instructions 1224 may also reside, completely or at least partially, within the main memory 1204, within static memory 1206, or within the hardware processor 1202 during execution thereof by the machine 1200. In an example, one or any combination of the hardware processor 1202, the main memory 1204, the static memory 1206. or the mass storage device 1216 may constitute machine readable media.

Specific examples of machine readable media include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine readable medium 1222 is illustrated as a single medium, the term “machine readable medium” may include a single medium or multiple media (e.g., a centralized or distributed database, and/or associated caches and servers) configured to store the one or more instructions 1224.

An apparatus of the machine 1200 may be one or more of a hardware processor 1202 (e.g., a central processing unit (CPU), a graphics processing unit (GPU), a hardware processor core, or any combination thereof), a main memory 1204 and a static memory 1206, sensors 1221, network interface device 1220, antennas 1260, a display device 1210, an input device 1212, a UI navigation device 1214, a mass storage device 1216, instructions 1224, a signal generation device 1218, and an output controller 1228. The apparatus may be configured to perform one or more of the methods and/or operations disclosed herein. The apparatus may be intended as a component of the machine 1200 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine readable medium” may include any medium that is capable of storing, encoding, or carrying instructions for execution by the machine 1200 and that cause the machine 1200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 1224 may further be transmitted or received over a communications network 1226 using a transmission medium via the network interface device 1220 utilizing any one of a number of transfer protocols (e.g., frame relay, internet protocol IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 1220 may include one or more physical jacks (e.g., Ethernet, coaxial, or phone jacks) or one or more antennas to connect to the communications network 1226. In an example, the network interface device 1220 may include one or more antennas 1260 to wirelessly communicate using at least one of single-input multiple-output (SIMO), multiple-input multiple-output (MEMO), or multiple-input single-output (MISO) techniques. In some examples, the network interface device 1220 may wirelessly communicate using Multiple User MIMO techniques. The term “transmission medium” shall be taken to include any intangible medium that is capable of storing, encoding or carrying instructions for execution by the machine 1200, and includes digital or analog communications signals or other intangible medium to facilitate communication of such software.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Example 1 is a system, comprising: hardware processing circuitry; one or more hardware memories storing instructions that when executed configure the hardware processing circuitry to perform operations comprising: receiving, from a client device, an indication of a characteristic of an object detection environment and an indication of a hardware property of the client device; searching, based on the characteristic, a plurality of super-nets; selecting, based on the search, a first super-net of the plurality of super-nets, the first super-net, trained on training data from an environment with the characteristic; extracting, from the first super-net, model data based on the indicated hardware property; and transmitting the model data to the client device.

In Example 2, the subject matter of Example 1 optionally includes wherein the client device is configured to perform object detection within the object detection environment based on the model data.

In Example 3, the subject matter of any one or more of Examples 1-2 optionally include wherein the indication is an indication of one or more of an ambient light level of the object detection environment, a weather condition of the object detection environment, or a location of the client device.

In Example 4, the subject matter of any one or more of Examples 1-3 optionally include wherein the indication is an indication of a location of the client device, the operations further comprising: identifying a region associated with the location, wherein the selecting of the first super-net is based on the identified region.

In Example 5, the subject matter of Example 4 optionally includes the operations further comprising predicting, based on the location of the client device, an object detection environment characteristic of the client device during a prospective time period, wherein the selection of the first super-net is based on the predicted object detection environment characteristic.

In Example 6, the subject matter of any one or more of Examples 1-5 optionally include the operations further comprising receiving a second indication of one or more of a model number, memory size, power consumption of the client device, CPU speed of the client device, CPU utilization, memory utilization, I/O bandwidth utilization, or graphics processing unit configuration, wherein the selecting of the model data is based on the second indication.

In Example 7, the subject matter of any one or more of Examples 1-6 optionally include the operations further comprising receiving a second indication of a latency condition of the client device or a throughput condition of the client device, wherein the selecting of the model data is based on the latency condition or the throughput condition.

In Example 8, the subject matter of any one or more of Examples 1-7 optionally include the operations further comprising receiving an indication of one or more confidence levels of an object recognition of the client device, wherein the selecting of the first super-net is based on the one or more confidence levels.

In Example 9, the subject matter of any one or more of Examples 1-8 optionally include the operations further comprising receiving a second indication of one or more objects of interest from the client device, wherein the selecting is based on the second indication.

In Example 10, the subject matter of any one or more of Examples 1-9 optionally include the operations further comprising: receiving, from the client device, a first plurality of requirements of model data; searching, based on the first plurality of requirements, a data store of model data; and identifying, based on the search, a best fit between the first plurality of requirements and model data included in the data store, wherein the selecting of the model data is based on the identifying.

In Example 11, the subject matter of Example 10 optionally includes the operations further comprising: generating first model data based on the first plurality of requirements of model data; receiving a second request for model data from a second client device, the second request indicating a second plurality of requirements equivalent to the first plurality of requirements; and providing, to the second client device, the first model data based on the second plurality of requirements.

Example 12 is at least one non-transitory computer readable storage medium comprising instructions that when executed configure hardware processing circuitry to perform operations comprising: receiving, from a client device, an indication of a characteristic of an object detection environment and an indication of a hardware property of the client device; searching, based on the characteristic, a plurality of super-nets; selecting, based on the search, a first super-net of the plurality of super-nets, the first super-net, trained on training data from an environment with the characteristic; extracting, from the first super-net, model data based on the indicated hardware property; and transmitting the model data to the client device.

In Example 13, the subject matter of Example 12 optionally includes wherein the client device is configured to perform object detection within the object detection environment based on the model data.

In Example 14, the subject matter of any one or more of Examples 12-13 optionally include wherein the indication is an indication of one or more of an ambient light level of the object detection environment, a weather condition of the object detection environment, or a location of the client device.

In Example 15, the subject matter of any one or more of Examples 12-14 optionally include wherein the indication is an indication of a location of the client device, the operations further comprising: identifying a region associated with the location, wherein the selecting of the first super-net is based on the identified region.

In Example 16, the subject matter of Example 15 optionally includes the operations further comprising predicting, based on the location of the client device, an object detection environment characteristic of the client device during a prospective time period, wherein the selection of the first super-net is based on the predicted object detection environment characteristic.

In Example 17, the subject matter of any one or more of Examples 12-16 optionally include the operations further comprising receiving a second indication of one or more of a model number, memory size, power consumption of the client device, CPU speed of the client device, CPU utilization, memory utilization, I/O bandwidth utilization, or graphics processing unit configuration, wherein the selecting of the model data is based on the second indication.

In Example 18, the subject matter of any one or more of Examples 12-17 optionally include the operations further comprising receiving a second indication of a latency condition of the client device or a throughput condition of the client device, wherein the selecting of the model data is based on the latency condition or the throughput condition.

In Example 19, the subject matter of any one or more of Examples 12-18 optionally include the operations further comprising receiving an indication of one or more confidence levels of an object recognition of the client device, wherein the selecting of the first super-net is based on the one or more confidence levels.

In Example 20, the subject matter of any one or more of Examples 12-19 optionally include the operations further comprising receiving a second indication of one or more objects of interest from the client device, wherein the selecting is based on the second indication.

In Example 21, the subject matter of any one or more of Examples 12-20 optionally include the operations further comprising: receiving, from the client device, a first plurality of requirements of model data; searching based on the first plurality of requirements, a data store of model data; and identifying, based on the search, a best fit between the first plurality of requirements and model data included in the data store, wherein the selecting of the model data is based on the identifying.

In Example 22, the subject matter of Example 21 optionally includes the operations further comprising: generating first model data based on the first plurality of requirements of model data; receiving a second request for model data from a second client device, the second request indicating a second plurality of requirements equivalent to the first plurality of requirements; and providing, to the second client device, the first model data based on the second plurality of requirements.

Example 23 is a method, comprising: receiving, from a client device, an indication of a characteristic of an object detection environment and an indication of a hardware property of the client device, searching, based on the characteristic, a plurality of super-nets; selecting, based on the search, a first super-net of the plurality of super-nets, the first super-net, trained on training data from an environment with the characteristic; extracting, from the first super-net, model data based on the indicated hardware property; and transmitting the model data to the client device.

In Example 24, the subject matter of Example 23 optionally includes wherein the client device is configured to perform object detection within the object detection environment based on the model data.

In Example 25, the subject matter of any one or more of Examples 23-24 optionally include wherein the indication is an indication of one or more of an ambient light level of the object detection environment, a weather condition of the object detection environment, or a location of the client device.

In Example 26, the subject matter of any one or more of Examples 23-25 optionally include wherein the indication is an indication of a location of the client device, the method further comprising: identifying a region associated with the location, wherein the selecting of the first super-net is based on the identified region.

In Example 27, the subject matter of Example 26 optionally includes predicting, based on the location of the client device, an object detection environment characteristic of the client device during a prospective time period, wherein the selection of the first super-net is based on the predicted object detection environment characteristic.

In Example 28, the subject matter of any one or more of Examples 23-27 optionally include receiving a second indication of one or more of a model number, memory size, power consumption of the client device, CPU speed of the client device, CPU utilization, memory utilization, I/O bandwidth utilization, or graphics processing unit configuration, wherein the selecting of the model data is based on the second indication.

In Example 29, the subject matter of any one or more of Examples 23-28 optionally include receiving a second indication of a latency condition of the client device or a throughput condition of the client device, wherein the selecting of the model data is based on the latency condition or the throughput condition.

In Example 30, the subject matter of any one or more of Examples 23-29 optionally include receiving an indication of one or more confidence levels of an object recognition of the client device, wherein the selecting of the first super-net is based on the one or more confidence levels.

In Example 31, the subject matter of any one or more of Examples 23-30 optionally include receiving a second indication of one or more objects of interest from the client device, wherein the selecting is based on the second indication.

In Example 32, the subject matter of any one or more of Examples 23-31 optionally include receiving, from the client device, a first plurality of requirements of model data; searching, based on the first plurality of requirements, a data store of model data; and identifying, based on the search, a best fit between the first plurality of requirements and model data included in the data store, wherein the selecting of the model data is based on the identifying.

In Example 33, the subject matter of Example 32 optionally includes generating first model data based on the first plurality of requirements of model data; receiving a second request for model data from a second client device, the second request indicating a second plurality of requirements equivalent to the first plurality of requirements; and providing, to the second client device, the first model data based on the second plurality of requirements.

Example 34 is an apparatus, comprising: means for receiving, from a client device, an indication of a characteristic of an object detection environment and an indication of a hardware property of the client device; means for searching, based on the characteristic, a plurality of super-nets; means for selecting, based on the search, a first super-net of the plurality of super-nets, the first super-net, trained on training data from an environment with the characteristic; means for extracting, from the first super-net, model data based on the indicated hardware property; and means for transmitting the model data to the client device.

In Example 35, the subject matter of Example 34 optionally includes wherein the client device is configured to perform object detection within the object detection environment based on the model data.

In Example 36, the subject matter of any one or more of Examples 34-35 optionally include wherein the indication is an indication of one or more of an ambient light level of the object detection environment, a weather condition of the object detection environment, or a location of the client device.

In Example 37, the subject matter of any one or more of Examples 34-36 optionally include wherein the indication is an indication of a location of the client device, the apparatus further comprising means for identifying a region associated with the location, wherein the means for selecting the first super-net is configured to base the selection of the first super-net on the identified region.

In Example 38, the subject matter of Example 37 optionally includes means for predicting, based on the location of the client device, an object detection environment characteristic of the client device during a prospective time period, wherein the means for selecting of the first super-net is configured to base the selection on the predicted object detection environment characteristic.

In Example 39, the subject matter of any one or more of Examples 34-38 optionally include means for receiving a second indication of one or more of a model number, memory size, power consumption of the client device, CPU speed of the client device, CPU utilization, memory utilization, I/O bandwidth utilization, or graphics processing unit configuration, wherein the means for selecting the model data is configured to base the selection on the second indication.

In Example 40, the subject matter of any one or more of Examples 34-39 optionally include means for receiving a second indication of a latency condition of the client device or a throughput condition of the client device, wherein the means for selecting the model data is configured to base the selection on the latency condition or the throughput condition.

In Example 41, the subject matter of any one or more of Examples 34-40 optionally include means for receiving an indication of one or more confidence levels of an object recognition of the client device, wherein the means for selecting the first super-net is configured to base the selection on the one or more confidence levels.

In Example 42, the subject matter of any one or more of Examples 34-41 optionally include receiving a second indication of one or more objects of interest from the client device, wherein the means for selecting is configured to base the selection on the second indication.

In Example 43, the subject matter of any one or more of Examples 34-42 optionally include means for receiving, from the client device, a first plurality of requirements of model data; means for searching, based on the first plurality of requirements, a data store of model data; and means for identifying, based on the search, a best fit between the first plurality of requirements and model data included in the data store, wherein the selecting of the model data is based on the identifying.

In Example 44, the subject matter of Example 43 optionally includes means for generating first model data based on the first plurality of requirements of model data; means for receiving a second request for model data from a second client device, the second request indicating a second plurality of requirements equivalent to the first plurality of requirements; and means for providing, to the second client device, the first model data based on the second plurality of requirements.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

1. A system, comprising:
hardware processing circuitry; and
one or more hardware memories storing instructions that when executed configure the hardware processing circuitry to perform operations comprising:
receiving, from a client device, an indication of a characteristic of an object detection environment and an indication of a hardware property of the client device;
searching, based on the characteristic, a plurality of super-nets;
selecting, based on the search, a first super-net of the plurality of super-nets, the first super-net, trained on training data from an environment with the characteristic;
extracting, from the first super-net, model data based on the indicated hardware property; and
transmitting the model data to the client device.

2. The system of claim 1, wherein the client device is configured to perform object detection within the object detection environment based on the model data.

3. The system of claim 1, wherein the indication is an indication of one or more of an ambient light level of the object detection environment, a weather condition of the object detection environment, or a location of the client device.

4. The system of claim 1, wherein the indication is an indication of a location of the client device, the operations further comprising: identifying a region associated with the location, wherein the selecting of the first super-net is based on the identified region.

5. The system of claim 4, the operations further comprising predicting, based on the location of the client device, an object detection environment characteristic of the client device during a prospective time period, wherein the selection of the first super-net is based on the predicted object detection environment characteristic.

6. The system of claim 1, the operations further comprising receiving a second indication of one or more of a model number, memory size, power consumption of the client device, CPU speed of the client device, CPU utilization, memory utilization, I/O bandwidth utilization, or graphics processing unit configuration, wherein the selecting of the model data is based on the second indication.

7. The system of claim 1, the operations further comprising receiving a second indication of a latency condition of the client device or a throughput condition of the client device, wherein the selecting of the model data is based on the latency condition or the throughput condition.

8. The system of claim 1, the operations further comprising receiving an indication of one or more confidence levels of an object recognition of the client device, wherein the selecting of the first super-net is based on the one or more confidence levels.

9. The system of claim 1, the operations further comprising receiving a second indication of one or more objects of interest from the client device, wherein the selecting is based on the second indication.

10. The system of claim 1, the operations further comprising:
receiving, from the client device, a first plurality of requirements of model data;
searching, based on the first plurality of requirements, a data store of model data; and
identifying, based on the search, a best fit between the first plurality of requirements and model data included in the data store, wherein the selecting of the model data is based on the identifying.

11. At least one non-transitory computer readable storage medium comprising instructions that when executed configure hardware processing circuitry to perform operations comprising:
receiving, from a client device, an indication of a characteristic of an object detection environment and an indication of a hardware property of the client device;
searching, based on the characteristic, a plurality of super-nets;
selecting, based on the search, a first super-net of the plurality of super-nets, the first super-net, trained on training data from an environment with the characteristic;
extracting, from the first super-net, model data based on the indicated hardware property; and
transmitting the model data to the client device.

12. The at least one non-transitory computer readable storage medium of claim 11, wherein the client device is configured to perform object detection within the object detection environment based on the model data.

13. The at least one non-transitory computer readable storage medium of claim 11, wherein the indication is an indication of one or more of an ambient light level of the object detection environment, a weather condition of the object detection environment, or a location of the client device.

14. The at least one non-transitory computer readable storage medium of claim 12, wherein the indication is an indication of a location of the client device, the operations further comprising: identifying a region associated with the location, wherein the selecting of the first super-net is based on the identified region.

15. The at least one non-transitory computer readable storage medium of claim 14, the operations further comprising predicting, based on the location of the client device, an object detection environment characteristic of the client device during a prospective time period, wherein the selection of the first super-net is based on the predicted object detection environment characteristic.

16. The at least one non-transitory computer readable storage medium of claim 11, the operations further comprising receiving a second indication of one or more of a model number, memory size, power consumption of the client device, CPU speed of the client device, CPU utilization, memory utilization, I/O bandwidth utilization, or graphics processing unit configuration, wherein the selecting of the model data is based on the second indication.

17. The at least one non-transitory computer readable storage medium of claim 11, the operations further comprising receiving a second indication of a latency condition of the client device or a throughput condition of the client device, wherein the selecting of the model data is based on the latency condition or the throughput condition.

18. The at least one non-transitory computer readable storage medium of claim 11, the operations further comprising receiving an indication of one or more confidence levels of an object recognition of the client device, wherein the selecting of the first super-net is based on the one or more confidence levels.

19. The at least one non-transitory computer readable storage medium of claim 11, the operations further comprising receiving a second indication of one or more objects of interest from the client device, wherein the selecting is based on the second indication.

20. The at least one non-transitory computer readable storage medium of claim 11, the operations further comprising:
receiving, from the client device, a first plurality of requirements of model data;
searching, based on the first plurality of requirements, a data store of model data; and
identifying, based on the search, a best fit between the first plurality of requirements and model data included in the data store, wherein the selecting of the model data is based on the identifying.

21. A method performed by hardware processing circuitry of a model deployment system, comprising:
receiving, from a client device, an indication of a characteristic of an object detection environment and an indication of a hardware property of the client device;
searching, based on the characteristic, a plurality of super-nets;
selecting, based on the search, a first super-net of the plurality of super-nets, the first super-net, trained on training data from an environment with the characteristic;
extracting, from the first super-net, model data based on the indicated hardware property; and
transmitting the model data to the client device.

22. The method of claim 21, wherein the indication is an indication of one or more of an ambient light level of the object detection environment, a weather condition of the object detection environment, or a location of the client device.

23. The method of claim 21, wherein the indication is an indication of a location of the client device, the method further comprising: identifying a region associated with the location, wherein the selecting of the first super-net is based on the identified region.

24. The method of claim 23, further comprising predicting, based on the location of the client device, an object detection environment characteristic of the client device during a prospective time period, wherein the selection of the first super-net is based on the predicted object detection environment characteristic.

25. The method of claim 21, further comprising:
receiving, from the client device, a first plurality of requirements of model data;
searching, based on the first plurality of requirements, a data store of model data; and
identifying, based on the search, a best fit between the first plurality of requirements and model data included in the data store, wherein the selecting of the model data is based on the identifying.
